(19) United States
(12) Patent Application Publication
(10) Pub. No.: US 2025/0335178 A1
(43) Pub. Date: Oct. 30, 2025

(54) METHODS AND APPARATUS TO IMPROVE ACTIVATION OF A FIRMWARE UPDATE

(71) Applicant: Texas Instruments Incorporated, Dallas, TX (US)

(72) Inventors: Sira Parasurama Rao, Richmond, TX (US); Alexander Tessarolo, Lindfield (AU); David P. Foley, Sugar Land, TX (US)

(21) Appl. No.: 18/647,543

(22) Filed: Apr. 26, 2024

(51) Int. Cl. G06F 8/654

(52) U.S. Cl. CPC G06F 8/654

(57) ABSTRACT

An example apparatus includes: a first portion of storage having a first firmware image, the first firmware image including first instructions; a second portion of storage having a second firmware image, the second firmware image including firmware update instructions; memory circuitry; and programmable circuitry configured to at least one of instantiate or execute the first instructions of the first portion of storage to: implement the first firmware image in the first portion of storage; and copy the firmware update instructions of the second firmware image to the memory circuitry.

### TECHNICAL FIELD

This description relates generally to firmware updates and, more particularly, to methods and apparatus to improve activation of a firmware update.

### BACKGROUND

Programmable circuitry is configurable to execute machine-readable instructions. Programmable circuitry is configurable by a firmware image stored in non-volatile memory. The firmware image includes a plurality of instructions that, when executed, cause the programmable circuitry to instantiate circuitry to perform operations. As electronics continue to advance, programmable circuitry has become capable of instantiating increasingly complex circuitry to perform increasingly advanced operations at increasing speeds.

### SUMMARY

For methods and apparatus to improve activation of a firmware update, an example apparatus includes a first portion of storage having a first firmware image, the first firmware image including first instructions; a second portion of storage having a second firmware image, the second firmware image including firmware update instructions; memory circuitry. The apparatus includes programmable circuitry configured to at least one of instantiate or execute the first instructions of the first portion of storage to: implement the first firmware image in the first portion of storage, and copy the firmware update instructions of the second firmware image to the memory circuitry. Other examples are described. The term “copy” in the above context and similar contexts includes to write to data from a first location to a second location to produce a result of copying.

For methods and apparatus to improve activation of a firmware update, an example method includes storing a first firmware image in a first portion of storage; storing a second firmware image in a second portion of storage, the second firmware image including firmware update instructions; implementing the first firmware image in the first portion of storage; and copying the firmware update instructions of the second firmware image to memory circuitry, the firmware update instructions to initialize the second firmware image. Other examples are described.

For methods and apparatus to improve activation of a firmware update, an example apparatus includes a first portion of storage having a first firmware image, the first firmware image including first instructions; a second portion of storage having a second firmware image, the second firmware image including firmware update instructions; memory circuitry. The apparatus includes programmable circuitry configured to at least one of instantiate or execute the first instructions of the first portion of storage to: implement the first firmware image in the first portion of storage, and implement the firmware update instructions in the memory circuitry, and implement the second firmware image in the second portion of storage after the implementation of the firmware update instructions. Other examples are described.

### BRIEF DESCRIPTION OF THE DRAWINGS

FIG. 1 is a block diagram of an example update environment in which example programmable circuitry uses memory circuitry to switch from an original firmware image to an updated firmware image.

FIG. 2 is a timing diagram of the memory circuitry of FIG. 1 during example update operations to switch from the original firmware image to an updated firmware image.

FIG. 3 is a block diagram of example firmware activation circuitry that implements the update operations of FIG. 2.

FIG. 4 is a flowchart representative of example machine-readable instructions and example operations that may be at least one of executed, instantiated, or performed using an example programmable circuitry implementation of the firmware activation circuitry of FIG. 3 to perform the update operations of FIG. 2.

FIG. 5 is a flowchart representative of example machine-readable instructions and example operations that may be at least one of executed, instantiated, or performed using an example programmable circuitry implementation of the firmware activation circuitry of FIG. 3 to activate the updated firmware image prior to switching from the original firmware image to the updated firmware image.

FIG. 6 is a block diagram of an example processing platform including programmable circuitry structured to execute, instantiate, or perform the example machine-readable instructions or perform the example operations of FIGS. 4 and 5 to implement the firmware activation circuitry of FIG. 3.

FIG. 7 is a block diagram of an example implementation of the programmable circuitry of FIG. 6.

FIG. 8 is a block diagram of another example implementation of the programmable circuitry of FIG. 6.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Programmable circuitry (e.g., a central processing unit (CPU), microprocessor circuitry, etc.) is configurable to execute machine-readable instructions. Programmable circuitry is configurable by a firmware image stored in non-volatile memory. The firmware image includes a plurality of instructions that, when executed, cause the programmable circuitry to instantiate circuitry to perform operations. As electronics continue to advance, programmable circuitry has become capable of instantiating increasingly complex circuitry to perform increasingly advanced operations at increasing speeds.

Some devices include circuitry and instructions to implement methods for updating executable files, such as a firmware image of programmable circuitry. Updating the firmware image allows designers to improve operations, add additional functionality, fix issues, etc. An updated version of a previous executable file (also referred to as an updated firmware image), which includes the desired improvements or additions, is created external to a device that is to execute the instructions. For example, manufacturers, suppliers, or designers can generate the updated version for a firmware update. Once created, an updated firmware image is supplied to the device that is to execute the instructions.

Some devices download the updated image to volatile memory circuitry (e.g., random-access memory circuitry) until the programmable circuitry can store the updated image in non-volatile memory (e.g., flash). Once in flash memory, devices may begin to perform operations to transition from executing machine-readable instructions of an original firmware image to executing machine-readable instructions of the updated firmware image. Some update methods of switching from the original firmware image to the updated firmware image occur responsive to power cycling (e.g., turning off and turning on) the programmable circuitry. An example of an update method that uses power cycling is described in “METHODS AND APPARATUS TO DIFFERENTIALLY UPDATE PROGRAMMABLE CIRCUITRY” U.S. patent application Ser. No. 18/228,462, which is incorporated by reference in its entirety and is assigned to the assignee of the instant application. However, in high-availability systems, which are systems that need to continuously remain powered on or have a small amount of downtime, update methods that rely on a power cycle are not reasonable or acceptable. High-availability systems need to update the firmware image without power cycling. Such methods of updating the firmware image are referred to as live firmware updates (LFUs). Additional example details of LFU can be found in commonly assigned U.S. patent application Publication Ser. No. 18/340,993, entitled “Firmware Update with Logical Address Remapping,” filed Jun. 26, 2023, which is incorporated by reference in its entirety.

One method of updating the firmware image without power cycling is to perform an A/B swap. An A/B swap is a series of operations to transition a first flash bank from an active state to an inactive state and transition a second flash bank from an inactive state to an active state. In devices that use A/B swap techniques, the non-volatile memory includes a first flash bank (referred to as flash bank A) and a second flash bank (referred to as flash bank B). The flash banks are portions of storage that store a firmware image. A flash bank containing a firmware image that programmable circuitry is executing instructions from is referred to as an active flash bank. When a flash bank is active, the programmable circuitry may execute instructions of the firmware image in the active flash bank. However, the programmable circuitry cannot write to the active flash bank. A flash bank containing a firmware image that the programmable circuitry is not executing instructions from is referred to as an inactive flash bank. When a flash bank is inactive, the programmable circuitry may read from and write to the inactive flash bank. However, the programmable circuitry cannot execute instructions of the firmware image in the inactive flash bank.

The programmable circuitry begins update operations by executing bootloader instructions from the first flash bank, which is the active flash bank. The bootloader instructions are instructions at the beginning of the original firmware image that cause the programmable circuitry to download and store the updated firmware image in the second flash bank. During update operations, the first flash bank stores the original firmware image, and the second flash bank stores the updated firmware image. The programmable circuitry may write the updated firmware image to the inactive second flash bank and may continue to execute instructions of the original firmware image in the active first flash bank.

Once the updated firmware image is stored in the second flash bank, the programmable circuitry waits to finish servicing an interrupt (also referred to as an alert, a trap, an exception, etc.) using instructions from the original firmware image in the first flash bank before beginning the A/B swap. The programmable circuitry services an interrupt by executing a series of corresponding instructions referred to as an interrupt service routine (ISR) (and may also be referred to as an interrupt handler). The programmable circuitry disables servicing interrupts prior to inactivating the first flash bank. After the interrupts are disabled, the programmable circuitry executes swap instructions from volatile memory (e.g., RAM) to inactivate the first flash bank and activate the second flash bank. The swap instructions are a series of instructions that modify the status of the flash banks.

Once active, the programmable circuitry begins executing instructions from the second flash bank. Before performing operations of the updated firmware image, the programmable circuitry executes instructions of a compiler LFU initialization routine to activate the updated firmware image. During activation, the programmable circuitry initializes variables and generates interrupt vectors specific to the updated firmware image. An interrupt vector identifies a location in the updated firmware image corresponding to instructions of an ISR for a specific interrupt. The programmable circuitry needs to generate an interrupt vector for each interrupt of the updated firmware image before being able to service interrupts. In some designs, the compiler LFU initialization routine further includes priority information, which establishes an initialization priority of the interrupt vectors or variables. In such designs, the compiler LFU initialization routine initializes interrupt vectors or variables that have relatively high priorities prior to relatively lower priority interrupt vectors or variables. The programmable circuitry may begin to execute instructions of the updated firmware image responsive to executing the instructions of the compiler LFU initialization routine, which initializes the update firmware image.

In some designs, the update operations, including activation of the updated firmware image, are constrained to an idle time between interrupts. However, designers have begun to use additional operations to prevent the idle time limitation in order to perform additional operations. An example of method of preventing the idle time limitation in the update process is described in “LIVE FIRMWARE UPDATE SWITCHOVER” U.S. patent application Ser. No. 17/692,670, which is incorporated by reference in its entirety and is assigned to the assignee of the instant application. However, as electronics continue to become increasingly complex, the instructions to activate an updated firmware image continue to include an increasing number of operations, which need an increasing amount of time to execute. In high-availability systems, increasing the number of activation operations, which increases the complexity of the compiler LFU initialization routine, excessively increases the delay between executing instructions of the original firmware image and executing instructions of the updated firmware image.

Examples described herein include methods and apparatus to improve activation of a firmware update by executing firmware activation instructions from volatile memory prior to an A/B swap. In some described examples, an updated firmware image includes firmware activation instructions that, when executed, cause programmable circuitry to perform activation operations while continuing to execute instructions of an original firmware image. In order to execute the firmware activation instructions, which are stored in an inactive flash bank, the programmable circuitry copies the firmware activation instructions to volatile memory. Once in volatile memory, the programmable circuitry may execute the firmware activation instructions and continue to execute instructions of the original firmware image. After executing the firmware activation instructions, the programmable circuitry performs an A/B swap, which activates the flash bank containing the updated firmware image.

Advantageously, executing the firmware activation instructions from volatile memory and prior to the A/B swap may decrease a number of instructions that the programmable circuitry needs to execute between servicing a final interrupt of the original firmware image and servicing a first interrupt of the updated firmware image. Advantageously, executing the firmware activation instructions, while continuing to service interrupts of the original firmware image, may decrease a number of instructions that need to be executed between disabling and enabling the interrupts. The reduced latency is especially important for safety reasons because some interrupts need to be serviced quickly. Advantageously, executing the firmware activation instructions from volatile memory and prior to the A/B swap may decrease the duration of time between executing instructions of the original firmware image and executing instructions of the updated firmware image. Advantageously, initializing vectors and variables prior to the A/B swap decreases the complexity of instructions that are executed after the A/B swap and prior to beginning to service interrupts by no longer needing to specify a priority of initialization. The reduced complexity is also important for further reducing latency.

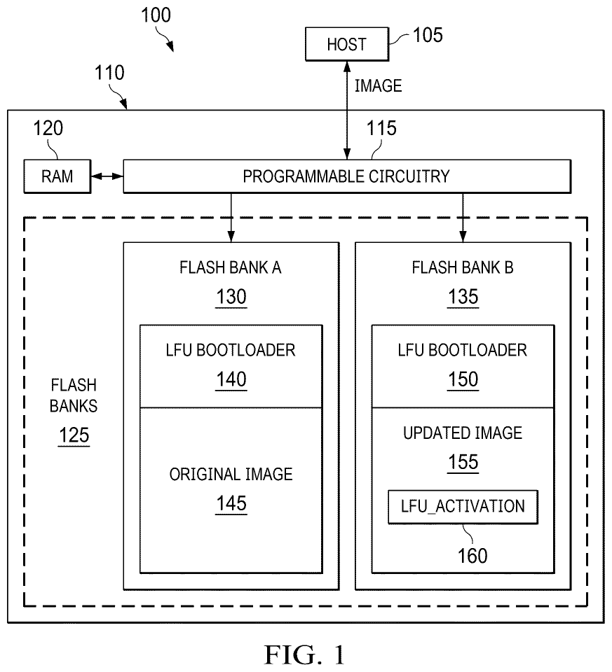

FIG. 1 is a block diagram of an example update environment 100. In the example of FIG. 1, the update environment 100 includes a host device 105 (HOST) and a target device 110. The example target device 110 of FIG. 1 includes example programmable circuitry 115, example volatile memory circuitry 120, and example non-volatile memory circuitry 125. The example non-volatile memory circuitry 125 of FIG. 1 includes a first example flash bank 130 and a second example flash bank 135. The first example flash bank 130 includes example bootloader instructions 140 and an example original firmware image 145. The second example flash bank 135 includes example bootloader instructions 150, an example updated firmware image 155, and example firmware activation instructions 160.

The host device 105 is coupled to the target device 110. In some examples, the host device 105 is directly coupled to the target device 110 by a physical connection (e.g., a cable, connector, etc.). In other examples, the host device 105 is coupled to the target device 110 by a wireless connection (e.g., connected over the air). In the example of FIG. 1, the host device 105 is structured to communicate with the target device 110, such as over a communication peripheral, interface, or channel (e.g., serial communication interface (SCI), universal asynchronous receiver-transmitter (UART) interface, inter-integrated circuit (I2C) interface, etc.).

The target device 110 is coupled to the host device 105. Alternatively, the target device 110 may be coupled to one or more additional devices, peripherals, etc. For example, the target device 110 may be coupled to external sensors, power supplies, motors, etc. In some examples, the target device 110 is structured as a server or rack power supply unit, merchant telecom rectifier, etc. In such examples, the target device 110 is considered a high-availability device, which needs to remain operational (e.g., powered on) during update operations.

The programmable circuitry 115 has a first terminal, a second terminal, a third terminal, and a fourth terminal. The first terminal of the programmable circuitry 115 is coupled to the host device 105. The second terminal of the programmable circuitry 115 is coupled to the volatile memory circuitry 120. The third and fourth terminals of the programmable circuitry 115 are coupled to the non-volatile memory circuitry 125. In the example of FIG. 1, the programmable circuitry 115 is communicatively coupled to the host device 105. In some examples, the programmable circuitry 115 may be referred to as microprocessor circuitry, a field-programmable gate array, a central processing unit (CPU), or alternative type of programmable circuitry.

The volatile memory circuitry 120 is coupled to the programmable circuitry 115. In the example of FIG. 1, the volatile memory circuitry 120 is structured as random-access memory circuitry (RAM). Alternatively, the volatile memory circuitry 120 may be an alternative type of memory circuitry.

The non-volatile memory circuitry 125 is coupled to the programmable circuitry 115. In the example of FIG. 1, the non-volatile memory circuitry 125 is structured as flash memory. Alternatively, the non-volatile memory circuitry 125 may be an alternative type of memory circuitry.

The flash bank 130 is coupled to the programmable circuitry 115. The flash bank 130 may be referred to as flash bank A. In the example of FIG. 1, the flash bank 130 is structured as a portion of storage. In some examples, the flash bank 130 is accessible by a reference memory address. The reference memory address maps the data of flash bank 130 to a memory address of the non-volatile memory circuitry 125. In such examples, the reference memory address may be referred to as a pointer.

The flash bank 135 is coupled to the programmable circuitry 115. The flash bank 135 may be referred to as flash bank B. In the example of FIG. 1, the flash bank 135 is structured as a portion of storage. In some examples, the flash bank 135 is accessible by a reference memory address. The reference memory address maps the data of flash bank 135 to a memory address of the non-volatile memory circuitry 125. In such examples, the reference memory address may be referred to as a pointer.

The bootloader instructions 140 are a series of machine-readable instructions that the programmable circuitry 115 performs following a power up. In some examples, the machine-readable instructions of the bootloader instructions, when executed, cause the programmable circuitry 115 to begin to perform operations of the original firmware image 145. In some examples, the bootloader instructions 140 are positioned at a fixed default memory location in the flash bank 130. The default memory location corresponds to a memory location that the programmable circuitry 115 is structured to initially execute instructions from. In such examples, the programmable circuitry 115 executes the bootloader instructions 140 prior to instructions of the original firmware image 145 responsive to the bootloader instructions 140 being at the fixed default memory location.

The original firmware image 145 is an executable file of machine-readable instructions that, when executed, implement operations of an original version of firmware. In some examples, the original firmware image 145 includes one or more series of instructions, which may be referred to as interrupt service routines (ISRs), corresponding to one or more notification events, which may be referred to as interrupts, alerts, exceptions, status flags, etc. In such examples, the programmable circuitry 115 executes one or more series of instructions responsive to a notification event (e.g., an interrupt). The programmable circuitry 115 considers the notification event serviced (also referred to as handled) responsive to executing the corresponding one or more series of instructions (e.g., ISR).

The bootloader instructions 150 are a series of machine-readable instructions that the programmable circuitry 115 performs following a power up. In some examples, the machine-readable instructions of the bootloader instructions, when executed, cause the programmable circuitry 115 to begin to perform operations of the updated firmware image 155. In some examples, the bootloader instructions 150 are positioned at a fixed default memory location in the flash bank 135. The default memory location corresponds to a memory location that the programmable circuitry 115 is structured to initially execute instructions from. In such examples, the programmable circuitry 115 executes the bootloader instructions 150 prior to instructions of the updated firmware image 155 responsive to the bootloader instructions 150 being at the fixed default memory location.

The updated firmware image 155 is an executable file of machine-readable instructions that, when executed, implements operations of an updated version of firmware. The updated firmware image 155 is structured similar to the original firmware image 145. However, in comparison to the original firmware image 145, the updated firmware image 155 may improve operations, add additional functionality, fix issues, etc. For example, the updated firmware image 155 may include one or more additional series of instructions (e.g., ISRs) corresponding to one or more additional interrupts.

The firmware activation instructions 160 are a series of machine-readable instructions that, when executed, cause the programmable circuitry 115 to perform activation operations specific to the updated firmware image 155. In some examples, the firmware activation instructions 160 are positioned at a fixed reference memory location in the flash bank 135. The fixed reference memory location corresponds to a memory location in the updated firmware image 155 that the programmable circuitry 115 may use to identify the firmware activation instructions 160 in the updated firmware image 155.

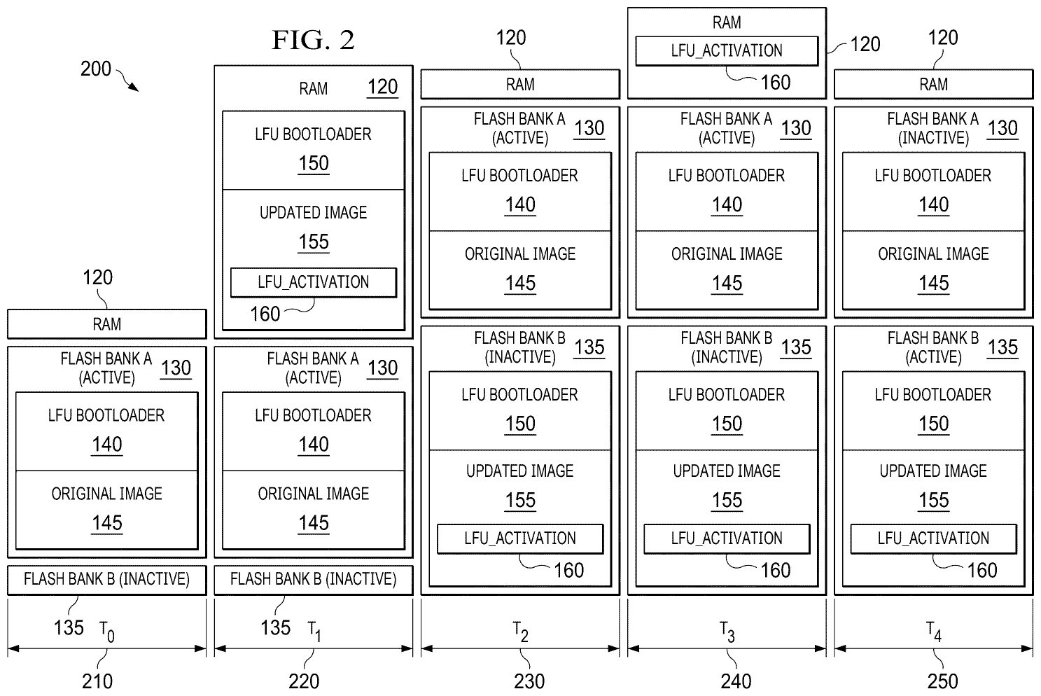

FIG. 2 is a timing diagram 200 of example update operations to switch from executing instructions of the original firmware image 145 of FIG. 1 to executing instructions of the updated firmware image 155 of FIG. 1. In the example of FIG. 2, the timing diagram 200 illustrates the volatile memory circuitry 120 of FIG. 1, the first flash bank 130 of FIG. 1, the second flash bank 135 of FIG. 1, the bootloader instructions 140 of FIG. 1, the original firmware image 145 of FIG. 1, the bootloader instructions 150 of FIG. 1, the updated firmware image 155 of FIG. 1, and the firmware activation instructions 160 of FIG. 1.

At a first time 210, the flash bank 130 stores the bootloader instructions 140 and the original firmware image 145. At the first time 210, the flash bank 130 is active. At the first time 210, the programmable circuitry 115 of FIG. 1 executes machine-readable instructions of the original firmware image 145 from the flash bank 130.

Between the first time 210 and a second time 220, the host device 105 of FIG. 1 begins supplying the updated firmware image 155 to the target device 110 of FIG. 1. At the second time 220, the programmable circuitry 115 stores one or more portions of the bootloader instructions 150, the updated firmware image 155, or the firmware activation instructions 160 in the volatile memory circuitry 120. In some examples, only portions of the bootloader instructions 150, the updated firmware image 155, or the firmware activation instructions 160 are stored in the volatile memory circuitry 120 at any given time. For example, the programmable circuitry 115 begins to transfer portions of the bootloader instructions 150, the updated firmware image 155, or the firmware activation instructions 160 to the flash bank 135 before the host device 105 finishes supplying the bootloader instructions 150, the updated firmware image 155, and the firmware activation instructions 160. At the second time 220, the flash bank 130 stores the bootloader instructions 140 and the original firmware image 145. Similar to the first time 210, at the second time 220, the programmable circuitry 115 executes machine-readable instructions of the original firmware image 145 from the flash bank 130.

At a third time 230, the flash bank 130 stores the bootloader instructions 140 and the original firmware image 145. Between the second time 220 and the third time 230, the programmable circuitry 115 completely transfers the bootloader instructions 150, the updated firmware image 155, and the firmware activation instructions 160 from the volatile memory circuitry 120 to the flash bank 135. Similar to the first time 210 and the second time 220, the programmable circuitry 115 executes machine-readable instructions of the original firmware image 145 from the flash bank 130.

Between the third time 230 and a fourth time 240, the programmable circuitry 115 transfers the firmware activation instructions 160 from the flash bank 135 to the volatile memory circuitry 120. At the fourth time 240, the flash bank 130 stores the bootloader instructions 140 and the original firmware image 145. At the fourth time 240, the flash bank 135 stores the bootloader instructions 150, the updated firmware image 155, and the firmware activation instructions 160. Similar to the first time 210, the second time 220, and the third time 230, the programmable circuitry 115 executes machine-readable instructions of the original firmware image 145 from the flash bank 130.

Advantageously, after the fourth time 240, the programmable circuitry 115 may execute the firmware activation instructions 160 from the volatile memory circuitry 120. Advantageously, the programmable circuitry 115 may perform activation operations specific to the updated firmware image 155 prior to activating the flash bank 135 and continue to execute instructions from the flash bank 130 when performing the activation operations.

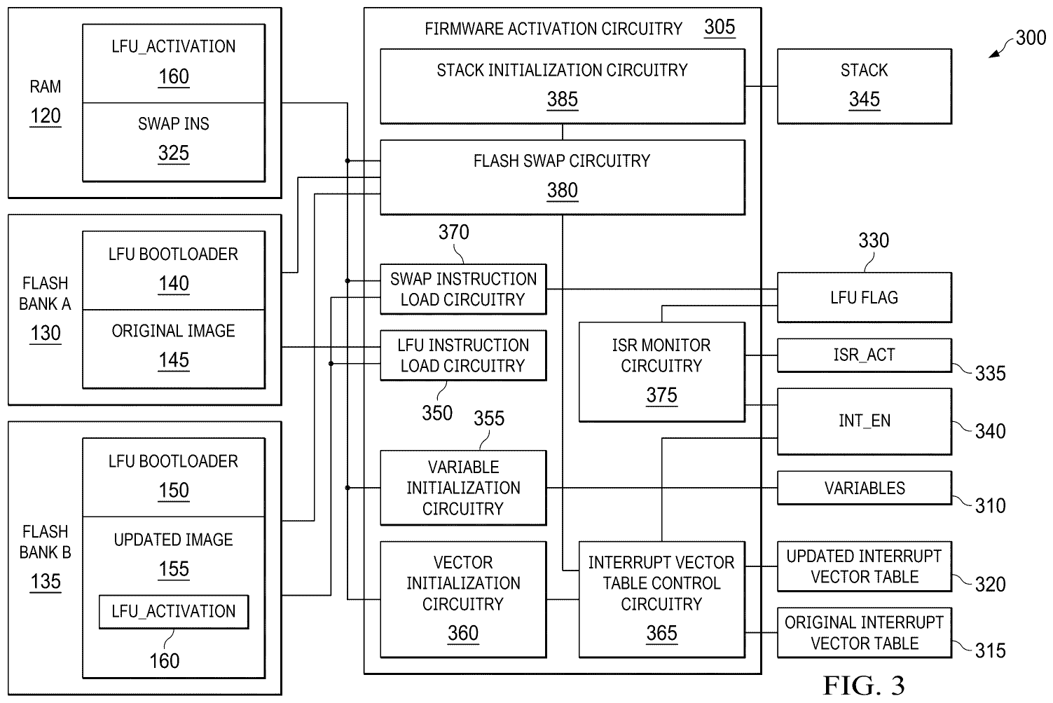

Between the fourth time 240 and a fifth time 250, the programmable circuitry 115 executes the firmware activation instructions 160 from the volatile memory circuitry 120. Also, between the fourth time 240 and the fifth time 250, the programmable circuitry 115 executes machine-readable instructions that perform the A/B swap between the flash banks 130, 135. Such instructions to perform the A/B swap may be referred to as swap instructions and are described in further detail in connection with FIGS. 3, 4, and 5, below. At the fifth time 250, the flash bank 130 is inactive and stores the bootloader instructions 140 and the original firmware image 145. At the fifth time 250, the flash bank 135 is active and stores the bootloader instructions 150, the updated firmware image 155, and the firmware activation instructions 160.

Advantageously, copying the firmware activation instructions 160 to the volatile memory circuitry 120 at the fourth time 240 allows the programmable circuitry 115 to execute the firmware activation instruction 160 prior to activating the flash bank 135. Advantageously, executing the firmware activation instructions 160 from volatile memory circuitry 120 and continuing to execute instructions of the original firmware image 145 may decrease the delay before executing instructions of the updated firmware image 155.

FIG. 3 is a block diagram of an example implementation of an update activation system 300 to activate the updated firmware image 155 of FIGS. 1 and 2 prior to switching from the original firmware image 145 of FIGS. 1 and 2 to the updated firmware image 155. The update activation system 300 of FIG. 3 may be instantiated (e.g., creating an instance of, bring into being for any length of time, materialize, implement, etc.) by the programmable circuitry 115 of FIG. 1 such as a Central Processor Unit (CPU) executing first instructions. Also or alternatively, the update activation system 300 of FIG. 3 may be instantiated (e.g., creating an instance of, bring into being for any length of time, materialize, implement, etc.) by (i) an Application Specific Integrated Circuit (ASIC) or (ii) a Field Programmable Gate Array (FPGA) structured or configured in response to execution of second instructions to perform operations corresponding to the first instructions. Some or all of the circuitry of FIG. 3 may, thus, be instantiated at the same or different times. Some or all of the circuitry of FIG. 3 may be instantiated, for example, in one or more threads executing concurrently on hardware or in series on hardware. Moreover, in some examples, some or all of the circuitry of FIG. 3 may be implemented by microprocessor circuitry executing instructions or FPGA circuitry performing operations to implement one or more virtual machines or containers.

In the example of FIG. 3, the update activation system 300 includes the volatile memory circuitry 120 of FIGS. 1 and 2, the flash banks 130, 135 of FIGS. 1 and 2, the bootloader instructions 140, 150 of FIGS. 1 and 2, the original firmware image 145 of FIGS. 1 and 2, the updated firmware image 155 of FIGS. 1 and 2, the firmware activation instructions 160 of FIGS. 1 and 2, firmware activation circuitry 305, variables 310, an original interrupt vector table 315, an updated interrupt vector table 320, example swap instructions 325, an update flag 330, an ISR active indication 335, an interrupt enable indication 340, and a data stack 345. The example firmware activation circuitry 305 of FIG. 3 includes example update instruction load circuitry 350, example variable initialization circuitry 355, example vector initialization circuitry 360, example interrupt vector table control circuitry 365, example swap instruction load circuitry 370, example ISR monitor circuitry 375, example flash swap circuitry 380, and example stack initialization circuitry 385.

In the example of FIG. 3, the volatile memory circuitry 120 stores the firmware activation instructions 160 and the swap instructions 325. In the example of FIG. 3, the first flash bank 130 stores the bootloader instructions 140 and the original firmware image 145. In the example of FIG. 3, the second flash bank 135 stores the bootloader instructions 150, the updated firmware image 155, and the firmware activation instructions 160.

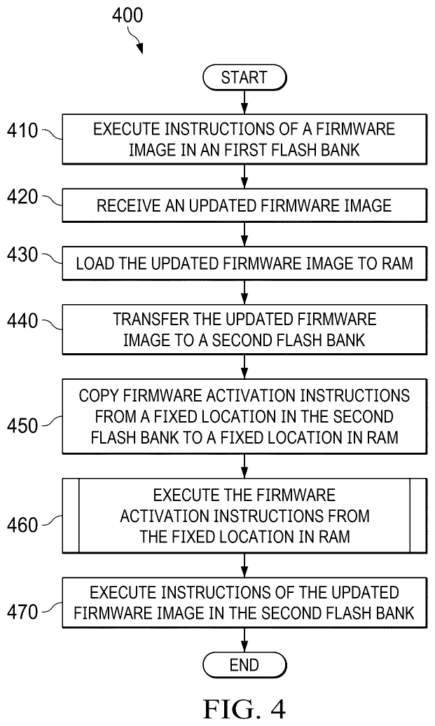

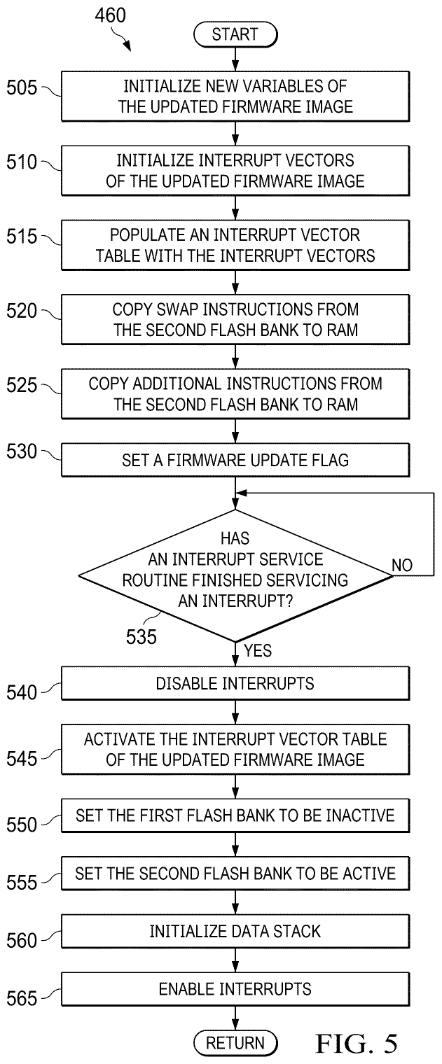

The firmware activation circuitry 305 is coupled to the volatile memory circuitry 120, the flash banks 130, 135, the interrupt vector tables 315, 320, the update flag 330, the ISR active indication 335, the interrupt enable indication 340, and the data stack 345. Example operations of the firmware activation circuitry 305 are illustrated and described in connection with FIGS. 4 and 5, below.

The variables 310 are one or more portions of internal memory of the programmable circuitry 115 (e.g., a local cache) structured to store values of variables of at least one of the original firmware image 145 or the updated firmware image 155. In some examples, the variables 310 represent global variables of the original firmware image 145 or the updated firmware image 155. In such examples, the programmable circuitry 115 sets values of the variables 310 during first operations and uses the value of the variables 310 during second operations.

The original interrupt vector table 315 is a portion of internal memory of the programmable circuitry 115 structured to store a plurality of interrupt vectors of the original firmware image 145. The original interrupt vector table 315 provides the programmable circuitry 115 with locations in the flash bank 130 or the volatile memory circuitry 120 of instructions of an interrupt service routine corresponding to a given interrupt.

The updated interrupt vector table 320 is a portion of internal memory of the programmable circuitry 115 structured to store a plurality of interrupt vectors of the updated firmware image 155. The updated interrupt vector table 320 provides the programmable circuitry 115 with locations in the flash bank 135 or the volatile memory circuitry 120 of instructions of an interrupt service routine corresponding to a given interrupt.

In some examples, similar to flash banks, the interrupt vector tables 315, 320 may be in an active state or an inactive state. When one of the interrupt vector tables 315, 320 are active, the programmable circuitry 115 uses interrupt vectors of the active one of the interrupt vector tables 315, 320 to service interrupts. When one of the interrupt vector tables 315, 320 are inactive, the firmware activation circuitry 305 may write to the inactive one of the interrupt vector tables 315, 320 to add or modify interrupt vectors. Also, the firmware activation circuitry 305 activates the one of the interrupt vector tables 315, 320 to correspond to which one of the flash banks 130, 135 are active.

The swap instructions 325 are a series of machine-readable instructions that, when executed, cause the programmable circuitry 115 to perform the A/B swap between the flash banks 130, 135. In some examples, the swap instructions 325 are a part of the firmware activation instructions 160. In such examples, the swap instructions 325 are copied to the volatile memory circuitry 120 with the firmware activation instructions 160. The firmware activation circuitry 305 is structured to execute the swap instructions 325 after performing the activation operations of the firmware activation instructions 160.

The update flag 330 is one or more bits in internal memory of the programmable circuitry 115 that represents whether the firmware activation circuitry 305 has performed the activation operations of the firmware activation instructions 160. When set, the update flag 330 identifies that the firmware activation circuitry 305 is ready to perform the A/B swap operations of the swap instructions 325. Also, the update flag 330 identifies that the firmware activation instructions 160 have been performed, which decreases the initialization complexity of the updated firmware image 155. In some examples, the update flag 330 is a single bit in a register.

The ISR active indication 335 is one or more bits in internal memory of the programmable circuitry 115 that represents whether the programmable circuitry 115 is servicing an interrupt. When set, the ISR active indication 335 identifies that programmable circuitry 115 is executing instructions from the volatile memory circuitry 120 or the active one of the flash banks 130, 135. In some examples, the ISR active indication 335 is a single bit in a register.

The interrupt enable indication 340 is one or more bits in internal memory of the programmable circuitry 115 that controls interrupts. When set, the interrupt enable indication 340 enables interrupts of the programmable circuitry 115. When cleared, the interrupt enable indication 340 disables interrupts of the programmable circuitry 115. In some examples, the interrupt enable indication 340 is a single bit in a register.

The data stack 345 is a portion of internal memory of the programmable circuitry 115 structured to store a buffer of data that the programmable circuitry 115 is to perform operations with. The data of the data stack 345 is specific to the one of the original firmware image 145 or the updated firmware image 155 that is in the active one of the flash banks 130, 135.

The update instruction load circuitry 350 is coupled to the volatile memory circuitry 120 and the flash bank 135. The update instruction load circuitry 350 copies the firmware activation instructions 160 from the flash bank 135 to the volatile memory circuitry 120. In some examples, the update instruction load circuitry 350 is instantiated by programmable circuitry executing update instruction load instructions to perform operations such as those represented by the flowchart(s) of FIGS. 4 and 5.

The variable initialization circuitry 355 is coupled to the volatile memory circuitry 120 and the variables 310. The variable initialization circuitry 355 initializes the variables 310 for the updated firmware image 155 based on one or more instructions of the firmware activation instructions 160. In some examples, the variable initialization circuitry 355 adds new variables to the variables 310 that are new to the updated firmware image 155. In some examples, the variable initialization circuitry 355 is instantiated by programmable circuitry executing variable initialization instructions to perform operations such as those represented by the flowchart of FIG. 5.

The vector initialization circuitry 360 is coupled to the volatile memory circuitry 120 and the interrupt vector table control circuitry 365. The vector initialization circuitry 360 generates interrupt vectors of the updated firmware image 155 based on one or more instructions of the firmware activation instructions 160. For example, the vector initialization circuitry 360 links interrupts of the updated firmware image 155 to locations of machine-instructions in the updated firmware image 155 that represent corresponding interrupt service routines. In some examples, the vector initialization circuitry 360 is instantiated by programmable circuitry executing vector initialization instructions to perform operations such as those represented by the flowchart of FIG. 5.

The interrupt vector table control circuitry 365 is coupled to the interrupt vector tables 315, 320, the interrupt enable indication 340, the interrupt vector initialization circuitry 360, the flash swap circuitry 380, and may be coupled to the volatile memory circuitry 120. The interrupt vector table control circuitry 365 receives interrupt vectors from the vector initialization circuitry 360 and the interrupt enable indication 340. The interrupt vector table control circuitry 365 populates the inactive one of the interrupt vector tables 315, 320 with interrupt vectors from the vector initialization circuitry 360. The interrupt vector table control circuitry 365 controls which of the interrupt vector tables 315, 320 are active. When the interrupt vector table control circuitry 365 determines that the interrupt enable indication 340 represents the interrupts being disabled during update operations, the interrupt vector table control circuitry 365 switches which one of the interrupt vector tables 315, 320 are active. The interrupt vector table control circuitry 365 supplies a vector table active indication to the volatile memory circuitry 120 and the flash swap circuitry 380. The vector table active indication specifies which one of the interrupt vector tables 315, 320 are active. In some examples, the interrupt vector table control circuitry 365 is instantiated by programmable circuitry executing interrupt vector table control instructions to perform operations such as those represented by the flowchart of FIG. 5.

The swap instruction load circuitry 370 is coupled to the volatile memory circuitry 120, the flash bank 135, and the update flag 330. The swap instruction load circuitry 370 copies the swap instructions 325 from the flash bank 135 to the volatile memory circuitry 120. The swap instruction load circuitry 370 sets the update flag 330 responsive to copying the swap instructions 325 to volatile memory circuitry 120. In some examples, when the swap instructions 325 are a part of the firmware activation instructions 160, the update instruction load circuitry 350 and the swap instruction load circuitry 370 may be combined. In both examples, the update flag 330 is set after an execution of the activation operations of the firmware activation instructions 160. In some examples, the swap instruction load circuitry 370 is instantiated by programmable circuitry executing swap instruction load instructions to perform operations such as those represented by the flowchart of FIG. 5.

The ISR monitor circuitry 375 is coupled to the update flag 330, the ISR active indication 335, and the interrupt enable indication 340. When the update flag 330 represents an A/B swap is ready to occur, the ISR monitor circuitry 375 waits for the ISR active indication 335 to represent the programmable circuitry 115 has finished servicing an interrupt. When the ISR active indication 335 represents the programmable circuitry 115 has finished servicing an interrupt, the ISR monitor circuitry 375 uses the interrupt enable indication 340 to disable interrupts. The ISR monitor circuitry 375 uses the interrupt enable indication 340 to enable interrupts after the A/B swap has completed. In some examples, the ISR monitor circuitry 375 is instantiated by programmable circuitry executing ISR monitor instructions to perform operations such as those represented by the flowchart of FIG. 5.

The flash swap circuitry 380 is coupled to the volatile memory circuitry 120, the flash banks 130, 135 and the interrupt vector table control circuitry 365. The flash swap circuitry 380 performs the operations of the swap instructions 325 responsive to the vector table active indication from the interrupt vector table control circuitry 365 indicating a switch in which of the interrupt vector tables 315, 320 are active. In some examples, the flash swap circuitry 380 adjusts reference memory addresses of the flash banks 130, 135 to activate or inactivate the flash banks 130, 135. Such an example is described in further detail in connection with FIG. 5, below. The flash swap circuitry 380 supplies a swap complete indication to the stack initialization circuitry 385 responsive to completing the A/B swap. In some examples, the flash swap circuitry 380 is instantiated by programmable circuitry executing flash activation instructions to perform operations such as those represented by the flowchart of FIG. 5.

The stack initialization circuitry 385 is coupled to the data stack 345 and the flash swap circuitry 380. In some examples, the stack initialization circuitry 385 clears the data stack 345 responsive to the swap complete indication from the flash swap circuitry 380. In some examples, the stack initialization circuitry 385 is instantiated by programmable circuitry executing stack initialization instructions to perform operations such as those represented by the flowchart of FIG. 5.

FIG. 4 is a flowchart representative of example machine-readable instructions and example operations 400 that may be at least one of executed, instantiated, or performed using an example programmable circuitry implementation of the firmware activation system 300 of FIG. 3 and/or more generally the update environment 100 of FIG. 1 to perform the update operations of FIG. 2. The example operations 400 of FIG. 4 begin at Block 410, at which, the programmable circuitry 115 of FIG. 1 executes instructions of a firmware image in a first flash bank. (Block 410). In some examples, the programmable circuitry 115 executes instructions of the original firmware image 145 of FIGS. 1, 2, and 3 from the first flash bank 130 of FIGS. 1, 2, and 3. In such examples, the first flash bank 130 of FIGS. 1, 2, and 3 is considered active. For example, at the first time 210 of FIG. 2, the first flash bank 130 is active. When active, the programmable circuitry 115 may execute instructions from the first flash bank 130. However, when active, the programmable circuitry 115 cannot write to the first flash bank 130.

The target device 110 of FIG. 1 receives an updated firmware image. (Block 420). In some examples, the host device 105 of FIG. 1 supplies the updated firmware image 155 of FIGS. 1, 2, and 3 to the target device 110. In such examples, the host device 105 and the target device 110 are communicatively coupled.

The programmable circuitry 115 loads the updated firmware image to RAM. (Block 430). In some examples, the programmable circuitry 115 writes one or more portions of the updated firmware image 155 to the volatile memory circuitry 120 of FIGS. 1, 2, and 3 as the target device 110 receives portions of the updated firmware image 155. For example, at the second time 220 of FIG. 2, the volatile memory circuitry 120 stores one or more portions of the updated firmware image 155. In some example operations, the programmable circuitry 115 temporarily stores portions of the updated firmware image 155 in the volatile memory circuitry 120.

The programmable circuitry 115 transfers the updated firmware image to a second flash bank. (Block 440). In some examples, the programmable circuitry 115 transfers the one or more portions of the updated firmware image 155, which are stored in the volatile memory circuitry 120, to the second flash bank 135. In such examples, the programmable circuitry 115 continues to transfer portions of the updated firmware image 155 to the second flash bank 135 until all portions of the updated firmware image 155 are in the second flash bank 135. For example, between the second time 220 and the third time 230 of FIG. 2, the programmable circuitry 115 transfers the updated firmware image 155 from the volatile memory circuitry 120 to the second flash bank 135.

The programmable circuitry 115 copies firmware activation instructions from a fixed location in the second flash bank to a fixed location in RAM. (Block 450). In some examples, the programmable circuitry 115 instantiates the update instruction load circuitry 350 of FIG. 3 responsive to storing the updated firmware image 155 in the second flash bank 135. In such examples, the update instruction load circuitry 350 copies the firmware activation instructions 160 of FIGS. 1, 2, and 3 from a pre-determined location in the updated firmware image 155 to the volatile memory circuitry 120. For example, at the fourth time 240 of FIG. 2, the volatile memory circuitry 120 includes the firmware activation instructions 160. In example operations, designers (e.g., users of the host device 105) position the firmware activation instructions 160 at the pre-determined location in the updated firmware image 155. In such example operations, the second flash bank 135 is inactive. When inactive, the update instruction load circuitry 350 may read the firmware activation instructions 160 at the predetermined memory location.

In some examples, the programmable circuitry 115 instantiates the firmware activation circuitry 305 of FIG. 3 by executing the firmware activation instructions from the fixed location in RAM. (Operations 460). In some examples, the programmable circuitry 115 instantiates the firmware activation circuitry 305 by executing the firmware activation instructions 160 from the volatile memory circuitry 120. In such example operations, the firmware activation circuitry 305 performs the operations 460 of FIG. 5. Advantageously, the programmable circuitry 115 executes the firmware activation instructions 160 from the volatile memory circuitry 120. Advantageously, the programmable circuitry 115 may execute the firmware activation instructions 160 prior to activating the second flash bank 135.

The programmable circuitry 115 executes instructions of the updated firmware image in the second flash bank. (Block 470). In some examples, the programmable circuitry 115 executes instructions of the updated firmware image 155 from the second flash bank 135. In such examples, the second flash bank 135 is considered active. For example, at the fifth time 250 of FIG. 2, the second flash bank 135 is active. When active, the programmable circuitry 115 may execute instructions from the second flash bank 135. Advantageously, performing the operations 460 prior to executing instructions of the updated firmware image 155 in the second flash bank 135 may decrease the duration of time needed to begin servicing interrupts. Advantageously, in systems that are continuously operating, designers may update the firmware between servicing interrupts.

Although example methods are described with reference to the flowchart illustrated in FIG. 4, many other methods of implementing the firmware activation system 300 and the update environment 100 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

FIG. 5 is a flowchart representative of example machine-readable instructions and example operations 460 that may be at least one of executed, instantiated, or performed using an example programmable circuitry implementation of the firmware activation circuitry 305 of FIG. 3, or more generally the firmware activation system 300 of FIG. 3 to activate the updated firmware image 155 of FIGS. 1, 2, and 3 prior to switching from the original firmware image 145 of FIGS. 1, 2, and 3 to the updated firmware image 155. The example operations 460 of FIG. 5 begin at Block 505, at which, the variable initialization circuitry 355 of FIG. 3 initializes new variables of the updated firmware image. (Block 505). In some examples, the variable initialization circuitry 355 initializes variables of the updated firmware image 155 by creating additional variables in the variables 310 of FIG. 3. For example, the variable initialization circuitry 355 creates the variables 310 by allocating one or more registers or portions of memory to a specific variable.

The vector initialization circuitry 360 of FIG. 3 initializes interrupt vectors of the updated firmware image. (Block 510). In some examples, the vector initialization circuitry 360 initializes interrupt vectors of the updated firmware image 155 by determining interrupts and locating instructions corresponding to interrupt service routines. In such examples, the vector initialization circuitry 360 forms the interrupt vectors by linking interrupts to the corresponding instructions of an interrupt service routine.

The interrupt vector table control circuitry 365 of FIG. 3 populates an interrupt vector table with the interrupt vectors. (Block 515). In some examples, the interrupt vector table control circuitry 365 populates the updated interrupt vector table 320 of FIG. 3 with the interrupt vectors determined by the vector initialization circuitry 360. Advantageously, firmware activation circuitry 305 may populate the updated interrupt vector table 320 before activating the second flash bank 135.

The swap instruction load circuitry 370 of FIG. 3 copies swap instructions from the second flash bank to RAM. (Block 520). In some examples, the swap instruction load circuitry 370 copies the swap instructions 325 of FIG. 3 from the second flash bank 135 to the volatile memory circuitry 120. In such examples, the programmable circuitry 115 is capable of executing the swap instructions 325 from the volatile memory circuitry 120. Alternatively, in some examples, the firmware activation instructions 160 include the swap instructions 325.

The swap instruction load circuitry 370 further copies additional instructions from the second flash bank to RAM. (Block 525). In some examples, the swap instruction load circuitry 370 copies additional instructions from the second flash bank 135 to the volatile memory circuitry 120. In such examples, the programmable circuitry 115 is capable of executing the additional instructions from the volatile memory circuitry 120 at a speed greater than executing from, when activated, the second flash bank 135. Advantageously, performance-critical instructions of the updated firmware image 155 are transferred to the volatile memory circuitry 120 prior to the A/B swap. Advantageously, the programmable circuitry 115 may execute the performance-critical instructions from the volatile memory circuitry 120 at speeds greater than from an active flash bank.

The swap instructions load circuitry 370 sets a firmware update flag. (Block 530). In some examples, the swap instructions load circuitry 370 sets the firmware update flag 330 of FIG. 3 responsive to a determination that the swap instructions 325 are in the volatile memory circuitry 120. Also, in some examples, the swap instructions load circuitry 370 confirms that the vector initialization circuitry 360 and the interrupt vector table control circuitry 365 have populated the updated interrupt vector table 320 prior to setting the firmware update flag 330.

The ISR monitor circuitry 375 of FIG. 3 determines if an interrupt service routine has finished servicing an interrupt. (Block 535). In some examples, the ISR monitor circuitry 375 receives the ISR active indication 335 of FIG. 3, which represents whether the programmable circuitry 115 is executing instructions of an interrupt service routine. In such examples, when the ISR active indication 335 is in a first state (e.g., a logical one, logic high, etc.) the programmable circuitry 115 is servicing an ISR and when the ISR active indication 335 is in a second state (e.g., a logical zero, logic low, etc.) the programmable circuitry 115 is not servicing an ISR. If the ISR monitor circuitry 375 determines that the CPU is servicing an interrupt (e.g., Block 535 returns a result of NO), control proceeds to return to Block 535.

If the ISR monitor circuitry 375 determines that the CPU has finished servicing an interrupt (e.g., Block 535 returns a result of YES), the ISR monitor circuitry 375 disables interrupts. (Block 540). In some examples, the ISR monitor circuitry 375 disables interrupts by generating the interrupt enable indication 340 of FIG. 3, which prevents the programmable circuitry 115 from servicing interrupts.

The interrupt vector table control circuitry 365 activates the interrupt vector table of the updated firmware image. (Block 545). In some examples, the interrupt vector table control circuitry 365 activates the updated interrupt vector table 320 responsive to receiving the interrupt enable indication 340 indicating that the interrupts are disabled. In such examples, the interrupt vector table control circuitry 365 inactivates the original interrupt vector table 315 of FIG. 3 responsive to receiving the interrupt enable indication 340 indicating that the interrupts are disabled. Advantageously, the programmable circuitry 115 may begin to use the updated interrupt vector table 320 to service interrupts of the updated firmware image 155.

The flash swap circuitry 380 of FIG. 3 sets the first flash bank to be inactive. (Block 550). In some examples, the flash swap circuitry 380 inactivates the first flash bank 130 by modifying reference memory addresses corresponding to the first flash bank 130. Reference memory addresses are memory mapped addresses (e.g., pointers) that the programmable circuitry 115 may use to access a corresponding portion of the non-volatile memory circuitry 125 of FIG. 1. For example, when the first flash bank 130 originally corresponds to reference memory addresses from 0x000000 to 0x200000, the flash swap circuitry 380 modifies the reference memory addresses of the first flash bank 130 to be from 0xA00000 to 0xC00000. In such an example, the original firmware image 145 is inactive when the first portion of storage 130 has reference memory addresses from 0xA00000 to 0xC00000.

The flash swap circuitry 380 sets the second flash bank to be active. (Block 555). In some examples, the flash swap circuitry 380 activates the second flash bank 135 by modifying reference memory addresses corresponding to the second flash bank 135. For example, when the second flash bank 135 originally corresponds to reference memory addresses from 0xA00000 to 0xC00000, the flash swap circuitry 380 modifies the reference memory addresses of the second flash bank 135 to be from 0x000000 to 0x200000. In such an example, the updated firmware image 155 is active when the second portion of storage 135 has reference memory addresses from 0x000000 to 0x200000.

The stack initialization circuitry 385 of FIG. 3 initializes data stack. (Block 560). In some examples, the stack initialization circuitry 385 initializes the data stack 345 of FIG. 3 by clearing data corresponding to the original firmware image 145.

The ISR monitor circuitry 375 enables interrupts. (Block 565). In some examples, the ISR monitor circuitry 375 enables interrupts by clearing the interrupt enable indication 340 of FIG. 3, which allows the programmable circuitry 115 to begin servicing interrupts using ISRs of the updated firmware image 155. Advantageously, the programmable circuitry 115 may begin servicing interrupts as soon as the flash swap circuitry 380 activates the second flash bank 135. Control proceeds to return.

Although example methods are described with reference to the flowchart illustrated in FIG. 5, many other methods of implementing the firmware activation system 300 may also be used in this description. For example, the order of execution of the blocks may be changed, or some of the blocks described may be changed, eliminated, or combined. Similarly, additional operations may be included in the manufacturing process before, in between, or after the blocks shown in the illustrated examples.

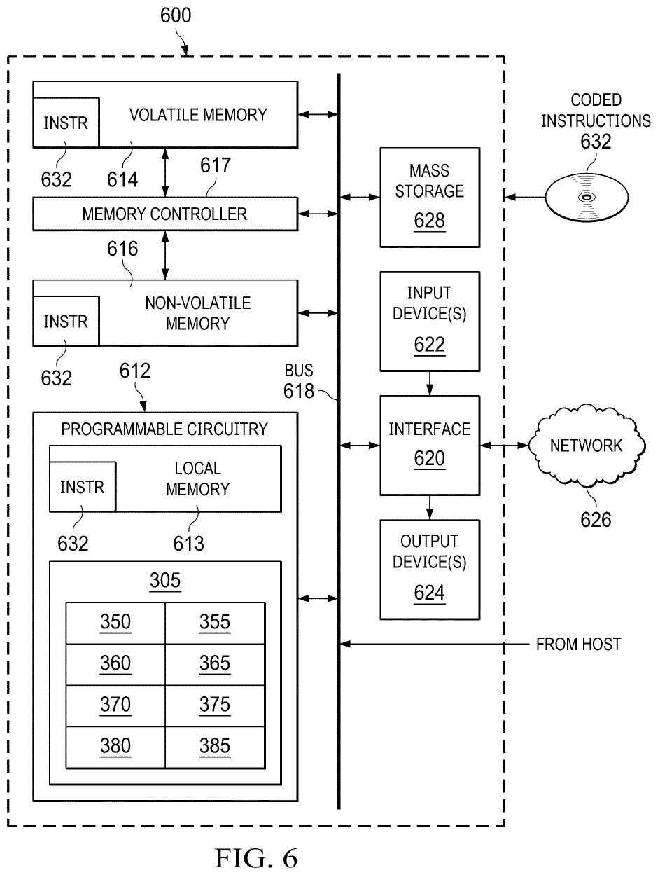

FIG. 6 is a block diagram of an example programmable circuitry platform 600 structured to one or a combination of execute or instantiate one or more of the example machine-readable instructions or the example operations of FIGS. 4 and 5 to implement the firmware activation circuitry of FIG. 3. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, or microcontrollers from any desired family or manufacturer. The programmable circuitry 612 may be implemented by one or more semiconductor based (e.g., silicon based) devices. In this example, the programmable circuitry 612 implements the update instruction load circuitry 350 of FIG. 3, the variable initialization circuitry 355 of FIG. 3, the vector initialization circuitry 360 of FIG. 3, the interrupt vector table control circuitry 365 of FIG. 3, the swap instruction load circuitry 370 of FIG. 3, the ISR monitor circuitry 375 of FIG. 3, the flash swap circuitry 380 of FIG. 3, and the stack initialization circuitry 385 of FIG. 3, or more generally the firmware activation circuitry 305 of FIG. 3.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by one or more Synchronous Dynamic Random Access Memory (SDRAM), Dynamic Random Access Memory (DRAM), RAMBUS® Dynamic Random Access Memory (RDRAM®), or any other type of RAM device. The non-volatile memory 616 may be implemented by one or a combination of flash memory or any other desired type of memory device. Access to the main memory 614, 616 of the illustrated examples is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in according to any type of interface standard, such as an Ethernet interface, a universal serial bus (USB) interface, a Bluetooth® interface, a near field communication (NFC) interface, a Peripheral Component Interconnect (PCI) interface, or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter one of or a combination of data or commands into the programmable circuitry 612. The input device(s) 622 can be implemented by, for example, one of or a combination of an audio sensor, a microphone, a camera (still or video), a keyboard, a button, a mouse, a touchscreen, a trackpad, a trackball, an isopoint device, or a voice recognition system.

One or more output devices 624 are also connected to the interface circuitry 620 of the illustrated example. The output device(s) 624 can be implemented, for example, by one of or a combination of display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, or speaker. The interface circuitry 620 of the illustrated example, thus, includes one of or a combination of a graphics driver card, a graphics driver chip, or graphics processor circuitry such as a GPU.

The interface circuitry 620 of the illustrated example also includes a communication device such as one of or a combination of a transmitter, a receiver, a transceiver, a modem, a residential gateway, a wireless access point, or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store one or more of firmware, software, or data. Examples of such mass storage discs or devices 628 include one or more magnetic storage devices (e.g., floppy disk, drives, HDDs, etc.), optical storage devices (e.g., Blu-ray disks, CDs, DVDs, etc.), RAID systems, or solid-state storage discs or devices such as flash memory devices and SSDs.

The machine-readable instructions 632, which may be implemented by the machine-readable instructions of FIGS. 4 and 5, may be stored in one of or a combination of the mass storage device 628, in the volatile memory 614, in the non-volatile memory 616, or on at least one non-transitory computer readable storage medium such as a CD or DVD which may be removable.

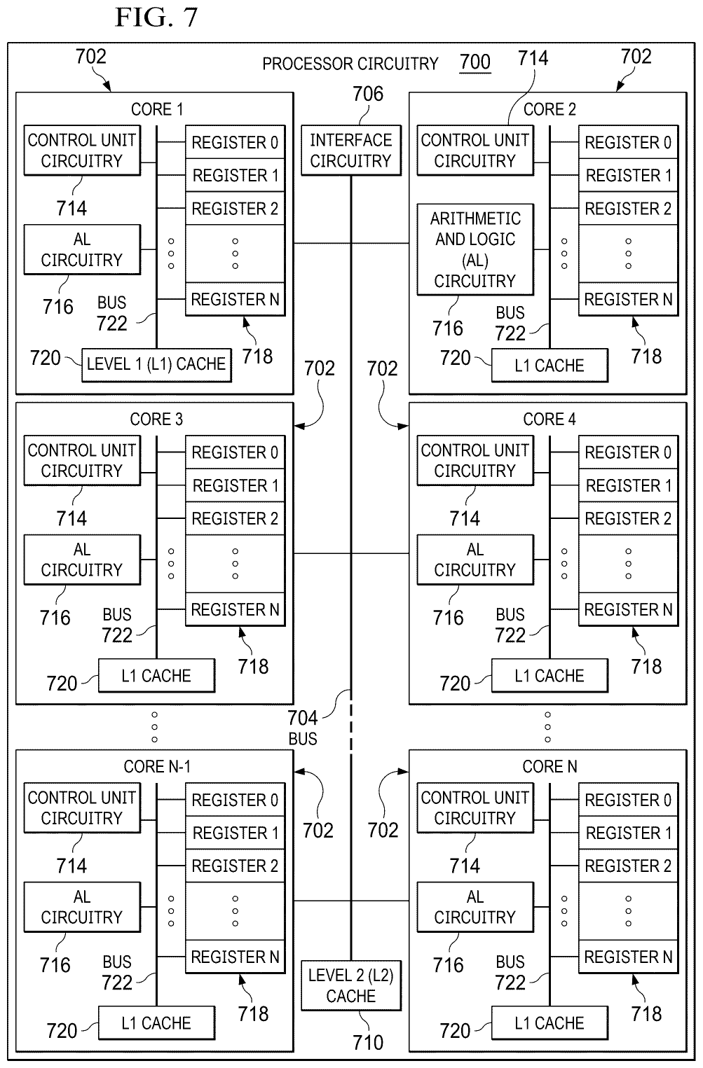

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 3 as logic circuits to perform operations corresponding to those machine-readable instructions. In some such examples, the circuitry of FIG. 3 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine-readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine-readable instructions or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Also or alternatively, the first bus 704 may be implemented by any other type of computing or electrical bus. The cores 702 may obtain data, instructions, and signals from one or more external devices by example interface circuitry 706. The cores 702 may output data, instructions, and signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and instructions. Data and instructions may be transferred (e.g., shared) by one of or a combination of writing to or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic or logic operations on the data within the corresponding core 702. The AL circuitry 716 of some examples performs integer-based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 or, more generally, the microprocessor 700 may include additional or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) or other circuitry may be present. The microprocessor 700 is a semiconductor device fabricated to include many transistors interconnected to implement the structures described above in one or more integrated circuits (ICs) contained in one or more packages.

The microprocessor 700 may include or cooperate with one or more accelerators (e.g., acceleration circuitry, hardware accelerators, etc.). In some examples, accelerators are implemented by logic circuitry to perform certain tasks more quickly and efficiently than can be done by a general-purpose processor. Examples of accelerators include ASICs and FPGAs such as those discussed herein. A GPU, DSP, or other programmable device can also be an accelerator. Accelerators may be on-board the microprocessor 700, in the same chip package as the microprocessor 700, or in one or more separate packages from the microprocessor 700.

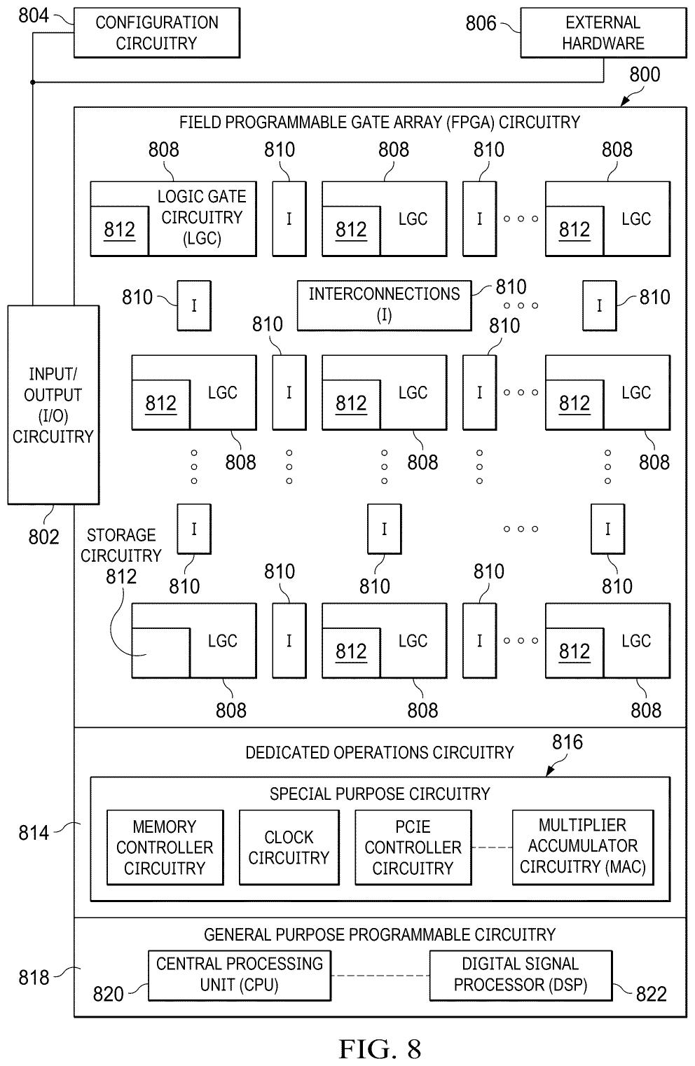

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine-readable instructions. However, once configured, the FPGA circuitry 800 instantiates the operations and functions corresponding to the machine-readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine-readable instructions represented by the flowchart(s) of FIGS. 4 and 5 but whose interconnections and logic circuitry are fixed once fabricated), the FPGA circuitry 800 of the example of FIG. 8 includes interconnections and logic circuitry that may be one of or a combination of configured, structured, programmed, and interconnected in different ways after fabrication to instantiate, for example, some or all of the operations/functions corresponding to the machine-readable instructions represented by the flowchart(s) of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and 5. As such, the FPGA circuitry 800 may be at least one of configured or structured to effectively instantiate some or all of the operations/functions corresponding to the machine-readable instructions of the flowchart(s) of FIGS. 4 and 5 as dedicated logic circuits to perform the operations/functions corresponding to those software instructions in a dedicated manner analogous to an ASIC. Therefore, the FPGA circuitry 800 may perform the operations/functions corresponding to the some or all of the machine-readable instructions of FIGS. 4 and 5 faster than the general-purpose microprocessor can execute the same.

In the example of FIG. 8, the FPGA circuitry 800 is at least one of configured or structured in response to being programmed (and/or reprogrammed one or more times) based on a binary file. In some examples, the binary file may be one of or both of compiled or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may at least one of access or load the binary file to cause the FPGA circuitry 800 of FIG. 8 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 800 of FIG. 8 to at least one of configure or structure the FPGA circuitry 800 of FIG. 8, or portion(s) thereof.

In some examples, the binary file is at least one of compiled, generated, transformed, or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is at least one of compiled, generated, or otherwise output from the uniform software platform based on the second instructions. In some examples, the FPGA circuitry 800 of FIG. 8 may at least one of access or load the binary file to cause the FPGA circuitry 800 of FIG. 8 to be at least one of configured or structured to perform the one or more operations/functions. For example, the binary file may be implemented by one of or a combination of a bit stream (e.g., one or more computer-readable bits, one or more machine-readable bits, etc.), data (e.g., computer-readable data, machine-readable data, etc.), or machine-readable instructions accessible to the FPGA circuitry 800 of FIG. 8 to at least one of configure or structure the FPGA circuitry 800 of FIG. 8, or portion(s) thereof.

The FPGA circuitry 800 of FIG. 8, includes example input/output (I/O) circuitry 802 to at least one of obtain or output data to/from at least one of example configuration circuitry 804 or external hardware 806. For example, the configuration circuitry 804 may be implemented by interface circuitry that may obtain a binary file, which may be implemented by one or more of a bit stream, data, or machine-readable instructions, to configure the FPGA circuitry 800, or portion(s) thereof. In some such examples, the configuration circuitry 804 may obtain the binary file from one of or a combination of a user, a machine (e.g., hardware circuitry (e.g., programmable or dedicated circuitry) that may implement an Artificial Intelligence/Machine Learning (AI/ML) model to generate the binary file, etc.), or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine-readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of one of or a combination of the electrical structures or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 or an example DSP 822. Other general purpose programmable circuitry 818 may also or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7.

Therefore, the programmable circuitry 612 of FIG. 6 may also be implemented by combining at least the example microprocessor 700 of FIG. 7 and the example FPGA circuitry 800 of FIG. 8. In some such hybrid examples, one or more cores 702 of FIG. 7 may execute a first portion of the machine-readable instructions represented by the flowchart(s) of FIGS. 4 and 5 to perform first operation(s)/function(s), the FPGA circuitry 800 of FIG. 8 may be at least one of configured or structured to perform second operation(s)/function(s) corresponding to a second portion of the machine-readable instructions represented by the flowcharts of FIGS. 4 and 5, and/or an ASIC may be at least one of configured or structured to perform third operation(s)/function(s) corresponding to a third portion of the machine-readable instructions represented by the flowcharts of FIGS. 4 and 5.

Some or all of the circuitry of FIG. 3 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be at least one of configured or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 700 of FIG. 7 may execute machine-readable instructions in one or more threads executing concurrently and/or in series. In some examples, the FPGA circuitry 800 of FIG. 8 may be at least one of configured or structured to carry out operations/functions concurrently and/or in series. Moreover, in some examples, some or all of the circuitry of FIG. 3 may be implemented within one or more virtual machines or containers executing on the microprocessor 700 of FIG. 7.

In some examples, the programmable circuitry 612 of FIG. 6 may be in one or more packages. For example, at least one of the microprocessor 700 of FIG. 7 or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

While an example manner of implementing the firmware activation circuitry of FIG. 1 is illustrated in FIG. 3, one or more of the elements, processes, or devices illustrated in FIG. 3 may be combined, divided, re-arranged, omitted, eliminated, or implemented in any other way. Further, the update instruction load circuitry 350 of FIG. 3, the variable initialization circuitry 355 of FIG. 3, the vector initialization circuitry 360 of FIG. 3, the interrupt vector table control circuitry 365 of FIG. 3, the swap instruction load circuitry 370 of FIG. 3, the ISR monitor circuitry 375 of FIG. 3, the flash swap circuitry 380 of FIG. 3, and the stack initialization circuitry 385 of FIG. 3, or more generally the firmware activation circuitry 305 of FIG. 3, may be implemented by hardware alone or by hardware in combination with software and firmware. Thus, for example, any of the update instruction load circuitry 350 of FIG. 3, the variable initialization circuitry 355 of FIG. 3, the vector initialization circuitry 360 of FIG. 3, the interrupt vector table control circuitry 365 of FIG. 3, the swap instruction load circuitry 370 of FIG. 3, the ISR monitor circuitry 375 of FIG. 3, the flash swap circuitry 380 of FIG. 3, and the stack initialization circuitry 385 of FIG. 3, or more generally the firmware activation circuitry 305 of FIG. 3, could be implemented by programmable circuitry in combination with one or more machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), or field programmable logic device(s) (FPLD(s)) such as FPGAs. Further still, the example firmware activation circuitry of FIG. 3 may include one or more elements, processes, or devices in addition to, or instead of, those illustrated in FIG. 3, or may include more than one of any or all of the illustrated elements, processes and devices.

Flowchart(s) representative of example machine-readable instructions, which may be executed by programmable circuitry to at least one of implement or instantiate the firmware activation circuitry of FIG. 3 or representative of example operations which may be performed by programmable circuitry to at least one of implement or instantiate the firmware activation circuitry of FIG. 3, are shown in FIGS. 4 and 5. The machine-readable instructions may be one or more executable programs or portion(s) of one or more executable programs for execution by programmable circuitry such as the programmable circuitry 612 shown in the example programmable circuitry platform 600 discussed below in connection with FIG. 6 and may be one or more function(s) or portion(s) of functions to be performed by the example programmable circuitry (e.g., an FPGA) discussed below in connection with FIG. 7 or 8. In some examples, the machine-readable instructions cause an operation, a task, etc., to be carried out or performed in an automated manner in the real-world. As used herein, “automated” means without human involvement.

The program may be embodied in instructions (e.g., software and/or firmware) stored on one or more non-transitory computer readable and/or machine-readable storage medium such as one of or a combination of cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), or any other storage device or storage disk. The instructions of the non-transitory computer readable and/or machine-readable medium may program or be executed by programmable circuitry located in one or more hardware devices, but the entire program or parts thereof could alternatively be executed or instantiated by one or more hardware devices other than the programmable circuitry or embodied in dedicated hardware. The machine-readable instructions may be distributed across multiple hardware devices or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example firmware activation circuitry may alternatively be used. For example, the order of execution of the blocks of the flowchart(s) may be changed, or some of the blocks described may be changed, eliminated, or combined. Also or alternatively, any or all of the blocks of the flow chart may be implemented by one or more hardware circuits (e.g., processor circuitry, discrete, integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations or local to one or more hardware devices (e.g., a single-core processor (e.g., a single core CPU), a multi-core processor (e.g., a multi-core CPU, an XPU, etc.)). For example, the programmable circuitry may be one of or a combination of a CPU or an FPGA located in the same package (e.g., the same integrated circuit (IC) package or in two or more separate housings), one or more processors in a single machine, multiple processors distributed across multiple servers of a server rack, multiple processors distributed across one or more server racks, etc., or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, or produce machine executable instructions. For example, the machine-readable instructions may be fragmented and stored on one or more storage devices, disks or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, or executable by a computing device or other machine. For example, the machine-readable instructions may be stored in multiple parts, which are individually compressed, encrypted, or stored on separate computing devices that when decrypted, decompressed, or combined form a set of one or more computer-executable or machine executable instructions that implement one or more functions or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions or the corresponding program(s) can be executed in whole or in part. Thus, machine-readable, computer readable or machine-readable media, as used herein, may include one or a combination of instructions and program(s) regardless of the particular format or state of the machine-readable instructions or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine-readable instructions) stored on one or more non-transitory computer readable or machine-readable media. As used herein, the terms non-transitory computer readable medium, non-transitory computer readable storage medium, non-transitory machine-readable medium, and non-transitory machine-readable storage medium are expressly defined to include any type of computer readable storage device or storage disk and to exclude propagating signals and to exclude transmission media. Examples of such non-transitory computer readable medium, non-transitory computer readable storage medium, non-transitory machine-readable medium, or non-transitory machine-readable storage medium include one or more optical storage devices, magnetic storage devices, an HDD, a flash memory, a read-only memory (ROM), a CD, a DVD, a cache, a RAM of any type, a register, or any other storage device or storage disk in which information is stored for any duration (e.g., for extended time periods, permanently, for brief instances, for temporarily buffering, for caching of the information). As used herein, the terms “non-transitory computer readable storage device” and “non-transitory machine-readable storage device” are defined to include any physical (mechanical, magnetic, electromechanical, or electrical) hardware to retain information for a time period, but to exclude propagating signals and to exclude transmission media. Examples of non-transitory computer readable storage devices or non-transitory machine-readable storage devices include one or a combination of random-access memory of any type, read only memory of any type, solid state memory, flash memory, optical discs, magnetic disks, disk drives, or redundant array of independent disks (RAID) systems. As used herein, the term “device” refers to physical structure such as one of or a combination of mechanical, electromechanical, or electrical equipment, hardware, or circuitry that may or may not be configured by computer readable instructions, machine-readable instructions, etc., or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +/−100 milliseconds.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function/or other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

What is claimed is:

1. An apparatus comprising:
a first portion of storage having a first firmware image, the first firmware image including first instructions;
a second portion of storage having a second firmware image, the second firmware image including firmware update instructions;
memory circuitry; and
programmable circuitry configured to at least one of instantiate or execute the first instructions of the first portion of storage to:
implement the first firmware image in the first portion of storage; and
copy the firmware update instructions of the second firmware image to the memory circuitry.

2. The apparatus of claim 1,
wherein the first portion of storage includes a first portion of flash memory, and
wherein the second portion of storage includes a second portion of flash memory.

3. The apparatus of claim 1, wherein the memory circuitry includes random-access memory circuitry.

4. The apparatus of claim 1, wherein the programmable circuitry is further configured to at least one of instantiate or execute the firmware update instructions of the memory circuitry to initialize an interrupt vector table of one or more interrupt service routines of the second firmware image.

5. The apparatus of claim 1, wherein the programmable circuitry is further configured to at least one of instantiate or execute the firmware update instructions of the memory circuitry to initialize variables of the second firmware image.

6. The apparatus of claim 1, wherein the programmable circuitry is further configured to at least one of instantiate or execute the firmware update instructions of the memory circuitry to:
disable interrupts;
initialize a data stack of the second firmware image;
enable interrupts; and
execute instructions of the second firmware image.

7. The apparatus of claim 6, wherein the programmable circuitry is further configured to at least one of instantiate or execute the firmware update instructions of the memory circuitry to:
initialize the data stack of the second firmware image after disabling the interrupts;
enable the interrupts after initializing the data stack of the second firmware image; and
execute instructions of the second firmware image after enabling the interrupts.

8. The apparatus of claim 1, wherein the first firmware image further includes swap instructions and the programmable circuitry is further configured to:
copy the swap instructions of the first firmware image to the memory circuitry;
execute the swap instructions from the memory circuitry; and
perform an A/B swap responsive to executing the swap instructions.

9. The apparatus of claim 8, wherein the programmable circuitry is further configured to at least one of instantiate or execute the swap instructions of the memory circuitry to:
set the first portion of the storage as inactive; and
set the second portion of the storage as active.

10. The apparatus of claim 8, wherein the programmable circuitry is configured to:
at least one of instantiate or execute the firmware update instructions of the memory circuitry; and
at least one of instantiate or execute the swap instructions of the memory circuitry after the at least one of instantiating or executing the firmware update instructions of the memory circuitry.

11. The apparatus of claim 1, wherein the second firmware image further includes swap instructions, the programmable circuitry is further configured to:
execute the swap instructions of the second portion of storage after at least one of instantiating or executing the firmware update instructions of the memory circuitry; and
perform an A/B swap responsive to executing the swap instructions.

12. A method comprising:
storing a first firmware image in a first portion of storage;
storing a second firmware image in a second portion of storage, the second firmware image including firmware update instructions;
implementing the first firmware image in the first portion of storage; and
copying the firmware update instructions of the second firmware image to memory circuitry, the firmware update instructions to initialize the second firmware image.

13. The method of claim 12, further comprising initializing the second firmware image by at least one of:
initializing variables of the second firmware image; or
initializing an interrupt vector table of one or more interrupt service routines of the second firmware image.

14. The method of claim 12, further comprising initializing the second firmware image by:
disabling interrupts;
initializing a data stack of the second firmware image after disabling the interrupts;
enabling the interrupts after initializing the data stack of the second firmware image; and
executing instructions of the second firmware image after enabling the interrupts.

15. The method of claim 12, further comprising:
implementing the firmware update instructions in the memory circuitry;
setting the first portion of the storage as inactive after implementing the firmware update instructions; and
setting the second portion of the storage as active after implementing the firmware update instructions.

16. An apparatus comprising:
a first portion of storage having a first firmware image, the first firmware image including first instructions;
a second portion of storage having a second firmware image, the second firmware image including firmware update instructions;
memory circuitry; and
programmable circuitry configured to at least one of instantiate or execute the first instructions of the first portion of storage to:
implement the first firmware image in the first portion of storage; and
implement the firmware update instructions in the memory circuitry; and
implement the second firmware image in the second portion of storage after the implementation of the firmware update instructions.

17. The apparatus of claim 16,
wherein the first portion of storage includes a first portion of flash memory,
wherein the second portion of storage includes a second portion of flash memory, and
wherein the memory circuitry includes random-access memory circuitry.

18. The apparatus of claim 16, wherein the programmable circuitry is further configured to at least one of instantiate or execute the firmware update instructions of the memory circuitry to:
initialize variables of the second firmware image; and
initialize an interrupt vector table of one or more interrupt service routines of the second firmware image.

19. The apparatus of claim 16, wherein the programmable circuitry is further configured to at least one of instantiate or execute the firmware update instructions of the memory circuitry to:
disable interrupts;
initialize a data stack of the second firmware image after disabling the interrupts;
enable the interrupts responsive to initializing the data stack of the second firmware image; and
executing instructions of the second firmware image after enabling the interrupts.

20. The apparatus of claim 16, wherein the first firmware image further includes swap instructions and wherein the programmable circuitry is further configured to copy the swap instructions of the first firmware image to the memory circuitry;
at least one of instantiate or execute the firmware update instructions of the memory circuitry;
at least one of instantiate or execute the swap instructions of the memory circuitry after the at least one of instantiating or executing the firmware update instructions of the memory circuitry; and
perform an A/B swap responsive to the at least one of instantiating or executing the swap instructions.
